(19) United States
(12) Patent Application Publication
(10) Pub. No.: US 2019/0286342 A1
(43) Pub. Date: Sep. 19, 2019

(54) EFFICIENT STORAGE DRIVE READ-WRITE HEAD VERIFICATION

(71) Applicant: SEAGATE TECHNOLOGY LLC, Cupertino, CA (US)

(72) Inventors: SweeSwee TANG, Singapore (SG); Jun CAI, Singapore (SG); YeeBoon GOH, Singapore (SG)

(73) Assignee: SEAGATE TECHNOLOGY LLC, Cupertino, CA (US)

(21) Appl. No.: 15/923,231

(22) Filed: Mar. 16, 2018

(51) Int. Cl. G06F 3/06

(52) U.S. Cl. CPC G06F 3/0619; G06F 3/0658; G06F 12/0223; G06F 3/0676; G06F 3/0659

(57) ABSTRACT

Systems and methods for efficient storage drive read-write head verification are described. In one embodiment, a storage system includes a storage drive and a hardware controller. In some embodiments, the hardware controller is configured to perform a data write; identify a location of the data write; generate a first check code from at least a portion of the data from the data write; detect a data read that overlaps at least a portion of the location of the data write; read the at least portion of the data from the location of the data write; and validate the data written to the location of the data write. In some cases, the data write includes writing data to a storage medium of the storage drive.

### SUMMARY

The present disclosure is directed to methods and systems for efficient storage drive read-write head verification. In some embodiments, the present systems and methods may perform efficient read-write head checks when data reads overlap previous data writes. The read-write head checks may be configured to verify read-write heads are performing read/write operations properly and not inducing errors such as when a read-write head writes data to a storage medium.

A storage system for efficient storage drive read-write head verification is described. In one embodiment, the storage system may include a storage drive and a hardware controller. In some embodiments, the hardware controller may be configured to perform a data write; identify a location of the data write; generate a first check code from at least a portion of the data from the data write; detect a data read that overlaps at least a portion of the location of the data write; read the at least portion of the data from the location of the data write; and validate the data written to the location of the data write. In some cases, the data write may include writing data to a storage medium of the storage drive.

In some cases, the hardware controller may be configured to generate a second check code from the at least portion of the data read from the location of the data write and compare the second check code to the first check code. In some cases, the hardware controller may be configured to permit the data read upon determining the second check code matches the first check code. In some cases, the hardware controller may be configured to block the data read upon determining the second check code fails to match the first check code.

In some cases, upon determining the second check code fails to match the first check code, the hardware controller may be configured to generate a notification indicating a data integrity error and report the notification to a host of the storage drive or an administrator of the storage drive, or to report the notification to both.

In some cases, identifying the location of the data write may include identifying a starting logical block address (LBA) of the data write. In some cases, identifying the location of the data write may include identifying a data length of the data write. In some cases, the data length may be measured by blocks. In some cases, the storage drive may include a hard disk drive.

In one embodiment, the hardware controller may be configured to index the data write. In some cases, indexing the data write may include indexing at least one of a head used to perform the data write, indexing the starting LBA of the data write, or indexing the first check code, or any combination thereof; and wherein indexing the data write includes storing the indexing of the data write on the storage medium.

A method for efficient storage drive read-write head verification is also described. In one embodiment, the method may include performing a data write; identifying a location of the data write; generating a first check code from at least a portion of the data from the data write; detecting a data read that overlaps at least a portion of the location of the data write; reading the at least portion of the data from the location of the data write; and validating the data written to the location of the data write. In some cases, the data write may include writing data to a storage medium of the storage drive.

A computer-program product to improve a computer system is also described. In one embodiment, the computer-program product may include a non-transitory computer-readable medium storing instructions thereon, the instructions being executable by one or more processors to perform a data write; identify a location of the data write; generate a first check code from at least a portion of the data from the data write; detect a data read that overlaps at least a portion of the location of the data write; read the at least portion of the data from the location of the data write; and validate the data written to the location of the data write. In some cases, the data write may include writing data to a storage medium of the storage drive.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, including their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components, including those having a dash and a second reference label, apply to other similar components. If only the first reference label is used in the specification, the description is applicable to any one of the similar components having the same first reference label irrespective of the second reference label.

FIG. 1 is a block diagram of an example of a system in accordance with various embodiments;

FIG. 2 shows a block diagram of a device in accordance with various aspects of this disclosure;

FIG. 3 shows a block diagram of one or more modules in accordance with various aspects of this disclosure;

FIG. 4 shows a diagram of a system in accordance with various aspects of this disclosure;

FIG. 5 is a flow chart illustrating an example of a method in accordance with various aspects of this disclosure; and

FIG. 6 is a flow chart illustrating an example of a method in accordance with various aspects of this disclosure.

### DETAILED DESCRIPTION

The following relates generally to efficient storage drive read-write head verification. For example, the present systems and methods are directed towards data integrity checks on storage drives. In some cases, the present systems and methods may generate a check code (e.g., compute a hash, cyclic redundancy check, etc.) of at least a portion of host written data on the storage drive. In some embodiments, the check code may be generated based on both the at least portion of data from the data write and location information associated with a location on the storage medium where the data is written.

In some embodiments, the hash may be cached on the storage drive. In some cases, the hash may be of at least a portion of most recent host written data. In some embodiments, the present systems and methods may monitor host reads of data stored on the storage drive. When the present systems and methods detect a host read that overlaps at least a portion of the most recent host written data, the present systems and methods may perform a data integrity check to verify the read/write head is writing data to the storage medium without inducing errors while writing the data.

Conversely, in a conventional system, the drive system zone may degrade after the several data writes resulting from multiple data integrity checks. With conventional systems, false alarms may be reported to host in cases where the data integrity of the head remains intact, but an error may still occur as a result of the degraded system zone.

In some cases, the present systems and methods may track at least one of a head used to write data, a physical location and/or range of the data written to the storage medium of the storage drive, and a check code generated from at least a portion of the written data. For example, when a host uses a certain head to write data to a certain location on the storage medium, the present systems and methods may index the head used to perform the write and/or the location of the written data (e.g., a logical block address (LBA) range, a transfer length, etc.).

As one example, the present systems and methods may detect head 0 being used to write data from the host to LBA 100 (e.g., starting at LBA 100) with a transfer length of 100 blocks. In this same example, the present systems and methods may generate a first check code on at least a portion of the written data. Subsequently, the present systems and methods may identify a data read subsequent to the data write, and may determine that a range of the data read overlaps the range of the data write of LBA 100 and transfer length of 100 blocks (e.g., from LBA 100 to LBA 199). For instance, the present systems and methods may determine that the data read starts at LBA 150 and has a transfer length of 10 blocks (e.g., LBA 150-159). Accordingly, the present systems and methods may perform a data integrity check on head 0 as a result of the detected read. In some cases, the data integrity check may include the present systems and methods determining the portion of data used to generate the first check code, reading the same portion of data, and generating a second check code from the same portion of data. In some cases, the present systems and methods may include comparing the first check code to the second check code and determining whether the first check code matches the second check code. Upon determining the check codes match, the present systems and methods may permit the data read to proceed. However, upon determining the check codes do not match, the present systems and methods may include at least one of generating a data integrity error, sending the data integrity error to a host of the storage drive, notifying an administrator of the data integrity error, blocking the data read, or any combination thereof.

In some embodiments, upon determining the check codes match, the present systems and methods may permit reads of data within the range of the data write of LBA 100 and transfer length of 100 blocks without any further data integrity checks.

In some embodiments, the present systems and methods may store a data structure for each head in a storage drive. The data structure may include an entry for a head, an entry for a starting LBA, and an entry for a check code. In one example, the head entry may be an 8 bit unsigned integer, the LBA entry may be a 64 bit unsigned integer, and the check code entry may be a 16 bit unsigned integer. The following is an example of a data structure used by the present systems and methods:

```
typedef struct recent_write_data
{
  uint8 Head;
  uint64 LBA;
  uint16 CheckCode;
};
```

In some embodiments, a given data structure may store the most recent write by head i, the starting LBA[i] (e.g., LBA[0]=100) and a check code generated based at least in part on the data from the write. In some examples, LBA[i] includes both a starting LBA and a data length. In some cases, the check code may be generated based at least in part on both the data from the write and the location information (e.g., LBA[i]). In some cases, the calculated CheckCode[i] may be saved in the data structure. Accordingly, when a host read overlaps a previous write on head i, a read is issued to LBA[i], and a check code is generated for data read back from LBA[i]. The newly generated check code is then compared with the stored CheckCode[i]. Upon determining a match, the data integrity check is passed. Otherwise, a data integrity check error may be reported to the host.

In some embodiments, the present systems and methods may store the latest data write performed by each head in the storage drive. For example, head 0 may be used to perform a first data write. Accordingly, the present systems and methods may store data in a first data structure indicating head 0 was used to perform the first data write and also store in the first data structure the location of the data written to the storage medium on the first data write. Head 2 may then be used to perform a second data write. Accordingly, the present systems and methods may store data in a second data structure indicating head 2 was used to perform the second data write and also store in the second data structure the location of the data written to the storage medium on the second data write. Head 1 may then be used to perform a third data write. Accordingly, the present systems and methods may store data in a third data structure indicating head 1 was used to perform the third data write and store in the third data structure the location of the data written to the storage medium on the third data write. Head 2 may then again be used to perform a fourth data write. Accordingly, the present systems and methods may remove data related to the second data write from the second structure and store data in the second data structure indicating head 2 was used to perform the fourth data write and also store in the second data structure the location of the data written to the storage medium on the fourth data write.

In some cases, the data stored in the data structure may be updated after a predetermined number of data writes. For example, a data structure may hold the most recent write or the X most recent writes associated with a given head, where X is a positive integer with a value of 2 or more. In some cases, a single data write operation may be associated with two or more heads. For example, a data write operation to LBA=0x100, length=0x100 may be associated with head 0 and head 1. The data write operation may cover both head 0 and head 1, where LBA=0x100, length=0x50 may be for head 0, and LBA=0x150, length=0x50 may be for head 1. In one embodiment, information associated with the first portion of the write by head 0 may be stored in a first data structure for head 0, while information associated with the second portion of the write by head 1 may be stored in a second data structure for head 1.

The present systems and methods have several benefits and improvements over conventional systems. For example, the present systems and methods avoid writing to a reserved zone for head/data integrity checks. Also, unlike conventional systems, the most recent host written data on a particular head is used for head/data integrity check with the present systems and methods. Also, the present systems and methods avoid potential frequent seeking to the same location which helps avoid the depletion issues of the conventional systems.

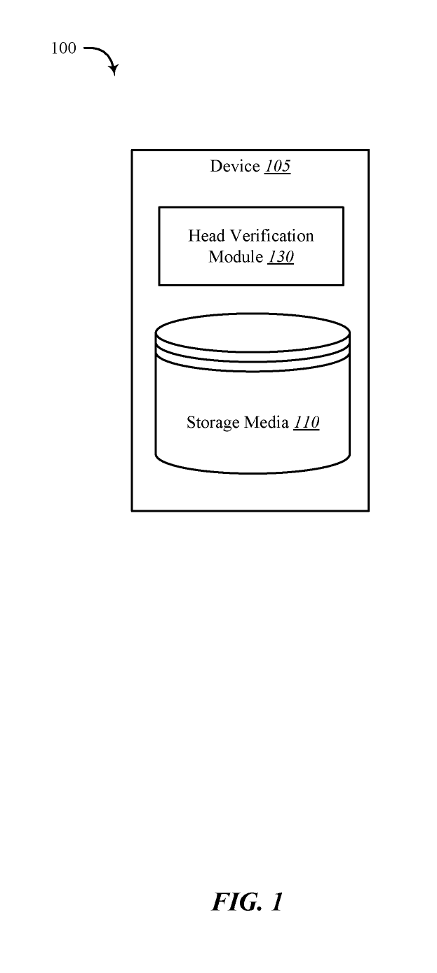

FIG. 1 is a block diagram illustrating one embodiment of an environment 100 in which the present systems and methods may be implemented. The environment may include device 105 and storage media 110. The storage media 110 may include any combination of hard disk drives, solid state drives, and hybrid drives that include both hard disk and solid state drives. In some embodiments, the storage media 110 may include shingled magnetic recording (SMR) storage drives. In some embodiments, the systems and methods described herein may be performed on a single device such as device 105. In some cases, the methods described herein may be performed on multiple storage devices or a network of storage devices such as a cloud storage system and/or a distributed storage system. Examples of device 105 include a storage server, a storage enclosure, a storage controller, storage drives in a distributed storage system, storage drives on a cloud storage system, storage devices on personal computing devices, storage devices on a server, or any combination thereof. In some configurations, device 105 may include head verification module 130. In one example, the device 105 may be coupled to storage media 110. In some embodiments, device 105 and storage media 110 may be components of flash memory or a solid state drive and/or another type of storage drive. Alternatively, device 105 may be a component of a host of the storage media 110 such as an operating system, host hardware system, or any combination thereof.

In one embodiment, device 105 may be a computing device with one or more processors, memory, and/or one or more storage devices. In some cases, device 105 may include a wireless storage device. In some embodiments, device 105 may include a cloud drive for a home or office setting. In one embodiment, device 105 may include a network device such as a switch, router, access point, or any combination thereof. In one example, device 105 may be operable to receive data streams, store and/or process data, and/or transmit data from, to, or in conjunction with one or more local and/or remote computing devices.

The device 105 may include a database. In some cases, the database may be internal to device 105. In some embodiments, storage media 110 may include a database. Additionally, or alternatively, device 105 may include a wired and/or a wireless connection to an external database. Additionally, as described in further detail herein, software and/or firmware (for example, stored in memory) may be executed on a processor of device 105. Such software and/or firmware executed on the processor may be operable to cause the device 105 to monitor, process, summarize, present, and/or send a signal associated with the operations described herein.

In some embodiments, storage media 110 may connect to device 105 via one or more networks. Examples of networks include cloud networks, local area networks (LAN), wide area networks (WAN), virtual private networks (VPN), a personal area network, near-field communication (NFC), a telecommunications network, wireless networks (using 802.11, for example), and cellular networks (using 3G and/or LTE, for example), or any combination thereof. In some configurations, the network may include the Internet and/or an intranet. The device 105 may receive and/or send signals over a network via a wireless communication link. In some embodiments, a user may access the functions of device 105 via a local computing device, remote computing device, and/or network device. For example, in some embodiments, device 105 may include an application that interfaces with a user. In some cases, device 105 may include an application that interfaces with one or more functions of a network device, remote computing device, and/or local computing device.

In one embodiment, the storage media 110 may be internal to device 105. As one example, device 105 may include a storage controller that interfaces with storage media of storage media 110. In one embodiment, head verification module 130 may perform one or more operations to improve storage drive read-write head verification. In some embodiments, head verification module 130 may perform efficient read-write head checks when data reads overlap previous data writes. In some cases, head verification module 130 may be configured to verify read-write heads are performing read/write operations properly and not inducing errors such as when a read-write head writes data to a storage medium without degrading the performance of device 105.

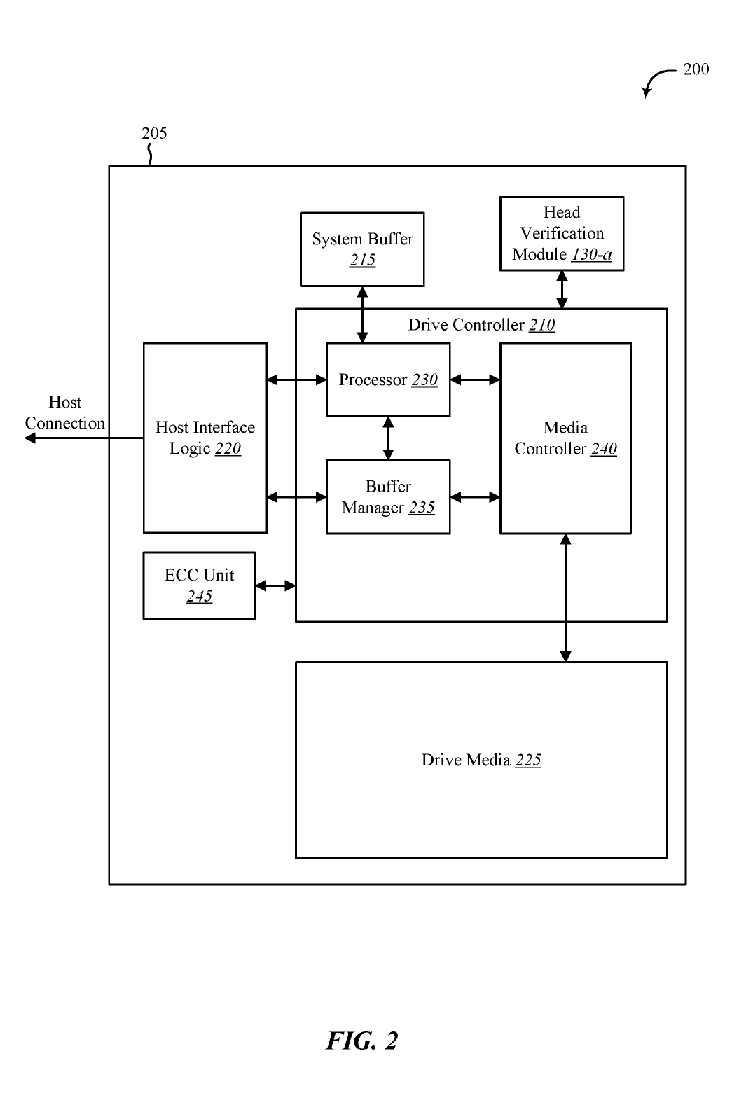

FIG. 2 shows a block diagram 200 of an apparatus 205 for use in electronic communication, in accordance with various aspects of this disclosure. The apparatus 205 may be an example of one or more aspects of device 105 described with reference to FIG. 1. The apparatus 205 may include a drive controller 210, system buffer 215, host interface logic 220, drive media 225, and head verification module 130-a. Each of these components may be in communication with each other and/or other components directly and/or indirectly.

One or more of the components of the apparatus 205, individually or collectively, may be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used such as Structured/Platform ASICs, Field Programmable Gate Arrays (FPGAs), and other Semi-Custom ICs, which may be programmed in any manner known in the art. The functions of each module may also be implemented, in whole or in part, with instructions embodied in memory formatted to be executed by one or more general and/or application-specific processors.

In one embodiment, the drive controller 210 may include a processor 230, a buffer manager 235, and a media controller 240. The drive controller 210 may process, via processor 230, read and write requests in conjunction with the host interface logic 220, the interface between the apparatus 205 and the host of apparatus 205. The system buffer 215 may hold data temporarily for internal operations of apparatus 205. For example, a host may send data to apparatus 205 with a request to store the data on the drive media 225. Drive media 225 may include one or more disk platters, flash memory, any other form of non-volatile memory, or any combination thereof. The drive controller 210 may process the request and store the received data in the drive media 225. In some cases, a portion of data stored in the drive media 225 may be copied to the system buffer 215 and the processor 230 may process or modify this copy of data and/or perform an operation in relation to this copy of data held temporarily in the system buffer 215. In some cases, error correction control (ECC) unit 245 may perform error correction on data stored in drive media 225.

In some embodiments, head verification module 130-a may include at least one of one or more processors, one or more memory devices, one or more storage devices, instructions executable by one or more processors stored in one or more memory devices and/or storage devices, or any combination thereof. Although depicted outside of drive controller 210, in some embodiments, head verification module 130-a may include software, firmware, and/or hardware located within drive controller 210 and/or operated in conjunction with drive controller 210. For example, head verification module 130-a may include at least a portion of processor 230, buffer manager 235, and/or media controller 240. In one example, head verification module 130-a may include one or more instructions executed by processor 230, buffer manager 235, and/or media controller 240.

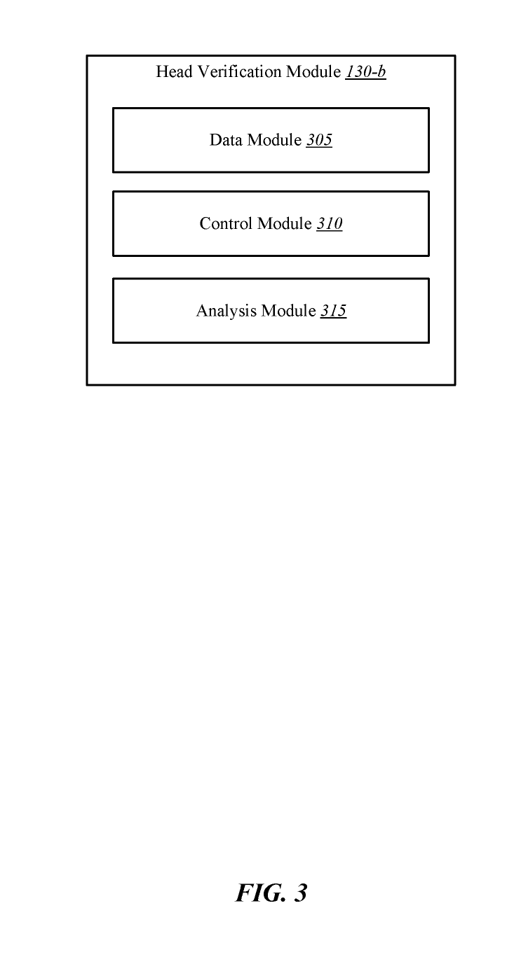

FIG. 3 shows a block diagram of head verification module 130-b. The head verification module 130-b may include one or more processors, memory, and/or one or more storage devices. The head verification module 130-b may include data module 305, control module 310, and analysis module 315. The head verification module 130-b may be one example of head verification module 130 of FIGS. 1 and/or 2. Each of these components may be in communication with each other.

In one embodiment, head verification module 130-b may include and/or perform one or more operations in conjunction with a storage system. In some cases, the storage system may include one or more storage drives, each storage drive including one or more hardware controllers. In some cases, head verification module 130-b may include and/or perform one or more operations in conjunction with one or more memory devices storing instructions and one or more processors configured to execute the instructions.

In one embodiment, data module 305 may be configured to perform a data write. In some cases, the data write includes data module 305 writing data to a storage medium of a storage drive. In some cases, data module 305 may perform a data write in conjunction with a read-write head.

In one embodiment, control module 310 may be configured to identify a location of the data write. In some cases, control module 310 may identify the location based at least in part on analysis resulting from analysis module 315 analyzing one or more aspects of the data write.

In some embodiments, control module 310 may be configured to generate a first check code from at least a portion of the data from the data write. In some embodiments, control module 310 may be configured to detect a data read that overlaps at least a portion of the location of the data write. In some cases, control module 310 may detect the data read overlapping the data write based at least in part on analysis of the data write and/or data read performed by analysis module 315.

In some embodiments, data module 305 may be configured to read the at least portion of the data from the location of the data write. In one embodiment, analysis module 315 may be configured to analyze the at least portion of the data from the location of the data write. In some embodiments, control module 310 may be configured to validate the data written to the location of the data write based at least in part on the analysis of the at least portion of the data from the location of the data write performed by analysis module 315.

In some embodiments, control module 310 may be configured to generate a second check code from the at least portion of the data read from the location of the data write. In one embodiment, generating the first check code and/or second check code may include generating a hash of the at least portion of the data read from the location of the data write. In one example, generating the first check code and/or second check code may include performing a cyclical redundancy check of the at least portion of the data read from the location of the data write.

In some embodiments, analysis module 315 may be configured to compare the second check code to the first check code. Upon determining the second check code matches the first check code, in one embodiment control module 310 may be configured to permit the data read. Upon determining the second check code fails to match the first check code, in one embodiment control module 310 may be configured to block the data read. In some cases, upon determining the second check code fails to match the first check code, control module 310 may be configured to generate a notification indicating a data integrity error. In some embodiments, control module 310 may be configured to report the notification to a host of the storage drive or an administrator of the storage drive, or report the notification to both the storage drive and the administrator of the storage drive.

In some cases, identifying the location of the data write may include identifying a starting logical block address (LBA) of the data write. In some embodiments, identifying the location of the data write may include control module 310 identifying a data length of the data write.

In some examples, the data length is measured by blocks. In some cases, the storage drive may include a hard disk drive. Additionally or alternatively, the storage drive may include a solid state drive. In some cases, the storage drive may include a hybrid drive that includes a hard disk drive and a solid state drive, a shingled magnetic recording (SMR) drive, or any combination thereof.

In some embodiments, control module 310 may be configured to index the data write. In some cases, indexing the data write may include control module 310 indexing at least one of a head used to perform the data write, indexing the starting LBA of the data write, or indexing the first check code, or indexing any combination thereof. In some cases, indexing the data write may include storing the one or more indexing values in a data structure. In some cases, indexing the data write may include storing the indexing of the data write on the storage medium.

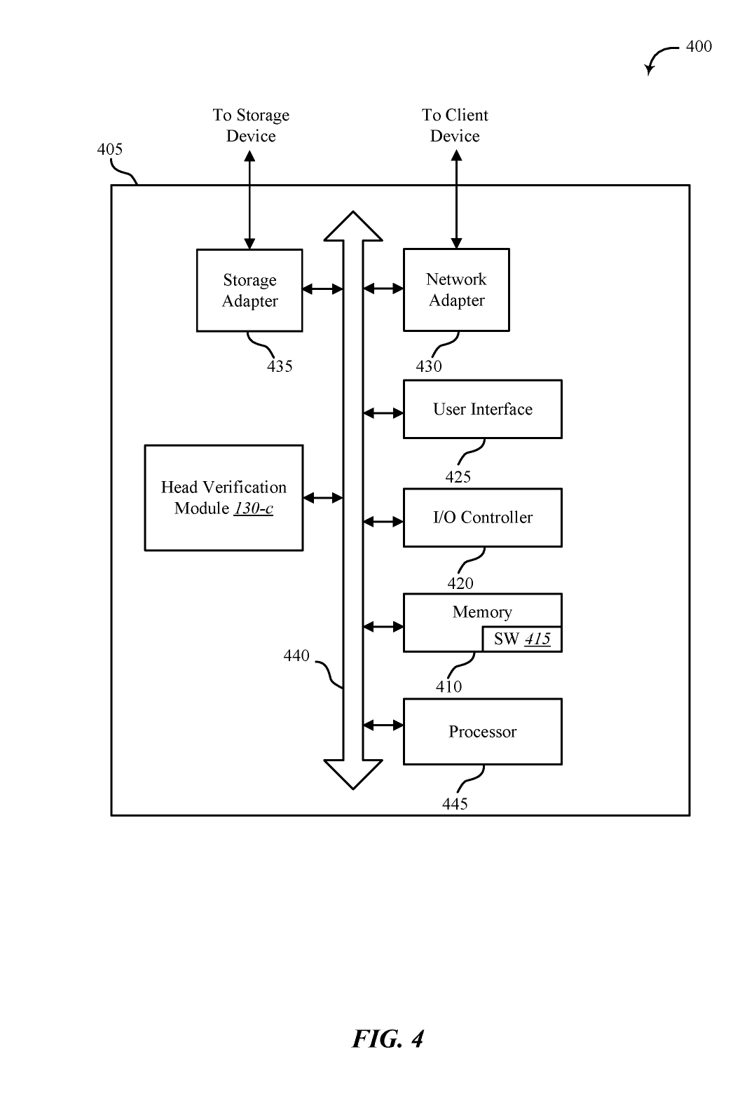

FIG. 4 shows a system 400 for efficient storage drive read-write head verification, in accordance with various examples. System 400 may include an apparatus 405, which may be an example of any one of device 105 of FIG. 1 and/or apparatus 205 of FIG. 2.

Apparatus 405 may include components for bi-directional voice and data communications including components for transmitting communications and components for receiving communications. For example, apparatus 405 may communicate bi-directionally with one or more storage devices and/or client systems. This bi-directional communication may be direct (apparatus 405 communicating directly with a storage system, for example) and/or indirect (apparatus 405 communicating indirectly with a client device through a server, for example).

Apparatus 405 may also include a processor module 445, and memory 410 (including software/firmware code (SW) 415), an input/output controller module 420, a user interface module 425, a network adapter 430, and a storage adapter 435. The software/firmware code 415 may be one example of a software application executing on apparatus 405. The network adapter 430 may communicate bi-directionally, via one or more wired links and/or wireless links, with one or more networks and/or client devices. In some embodiments, network adapter 430 may provide a direct connection to a client device via a direct network link to the Internet via a POP (point of presence). In some embodiments, network adapter 430 of apparatus 405 may provide a connection using wireless techniques, including digital cellular telephone connection, Cellular Digital Packet Data (CDPD) connection, digital satellite data connection, and/or another connection. The apparatus 405 may include head verification module 130-c, which may perform the functions described above for the head verification module 130 of FIGS. 1, 2, and/or 3.

The signals associated with system 400 may include wireless communication signals such as radio frequency, electromagnetics, local area network (LAN), wide area network (WAN), virtual private network (VPN), wireless network (using 802.11, for example), cellular network (using 3G and/or LTE, for example), and/or other signals. The network adapter 430 may enable one or more of WWAN (GSM, CDMA, and WCDMA), WLAN (including BLUETOOTH® and Wi-Fi), WMAN (WiMAX) for mobile communications, antennas for Wireless Personal Area Network (WPAN) applications (including RFID and UWB), or any combination thereof.

One or more buses 440 may allow data communication between one or more elements of apparatus 405 such as processor module 445, memory 410, I/O controller module 420, user interface module 425, network adapter 430, and storage adapter 435, or any combination thereof.

The memory 410 may include random access memory (RAM), read only memory (ROM), flash memory, and/or other types. The memory 410 may store computer-readable, computer-executable software/firmware code 415 including instructions that, when executed, cause the processor module 445 to perform various functions described in this disclosure. Alternatively, the software/firmware code 415 may not be directly executable by the processor module 445 but may cause a computer (when compiled and executed, for example) to perform functions described herein. Alternatively, the computer-readable, computer-executable software/firmware code 415 may not be directly executable by the processor module 445, but may be configured to cause a computer, when compiled and executed, to perform functions described herein. The processor module 445 may include an intelligent hardware device, for example, a central processing unit (CPU), a microcontroller, an application-specific integrated circuit (ASIC), field programmable gate array (FPGA), or any combination thereof.

In some embodiments, the memory 410 may contain, among other things, the Basic Input-Output system (BIOS) which may control basic hardware and/or software operation such as the interaction with peripheral components or devices. For example, at least a portion of the head verification module 130-c to implement the present systems and methods may be stored within the system memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface such as network adapter 430.

Many other devices and/or subsystems may be connected to and/or included as one or more elements of system 400 (for example, a personal computing device, mobile computing device, smart phone, server, internet-connected device, cell radio module, or any combination thereof). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be a mobile device operation system, a desktop/laptop operating system, or another known operating system.

The I/O controller module 420 may operate in conjunction with network adapter 430 and/or storage adapter 435. The network adapter 430 may enable apparatus 405 with the ability to communicate with client devices such as device 105 of FIG. 1, and/or other devices over a communication network. Network adapter 430 may provide wired and/or wireless network connections. In some cases, network adapter 430 may include an Ethernet adapter or Fibre Channel adapter. Storage adapter 435 may enable apparatus 405 to access one or more data storage devices such as storage media 110. The one or more data storage devices may include two or more data tiers each. The storage adapter 435 may include one or more of an Ethernet adapter, a Fibre Channel adapter, Fibre Channel Protocol (FCP) adapter, a SCSI adapter, and iSCSI protocol adapter.

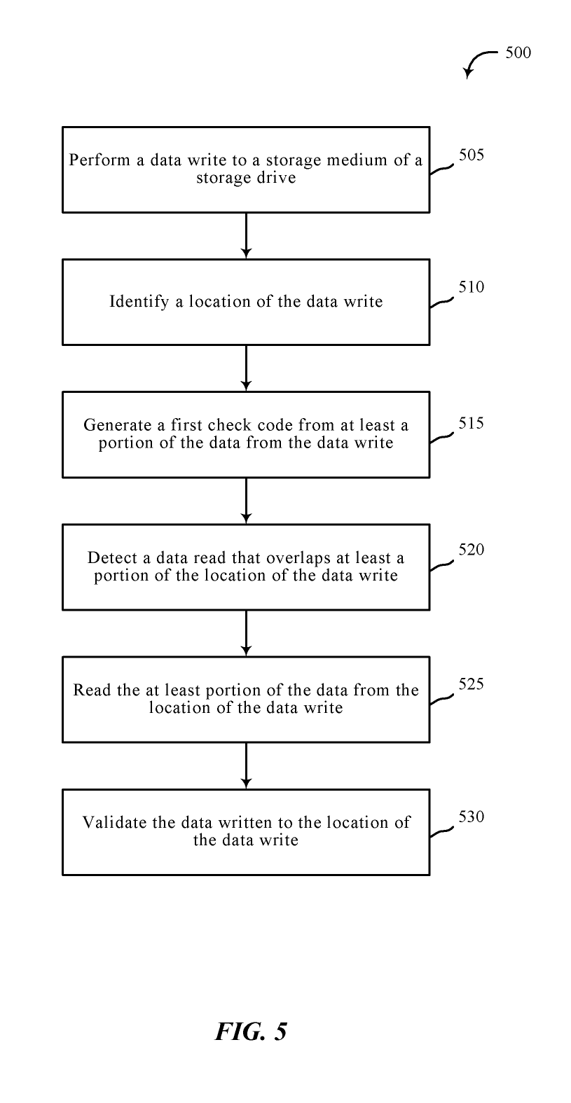

FIG. 5 is a flow chart illustrating an example of a method 500 for efficient storage drive read-write head verification, in accordance with various aspects of the present disclosure. One or more aspects of the method 500 may be implemented in conjunction with device 105 of FIG. 1, apparatus 205 of FIG. 2, and/or head verification module 130 depicted in FIGS. 1, 2, 3, and/or 4. In some examples, a backend server, computing device, and/or storage device may execute one or more sets of codes to control the functional elements of the backend server, computing device, and/or storage device to perform one or more of the functions described below. Additionally or alternatively, the backend server, computing device, and/or storage device may perform one or more of the functions described below using special-purpose hardware.

At block 505, method 500 may include performing a data write. In some cases, the data write may include method 500 writing data to a storage medium of a storage drive. At block 510, method 500 may include identifying a location of the data write. At block 515, method 500 may include generating a first check code from at least a portion of the data from the data write.

At block 520, method 500 may include detecting a data read that overlaps at least a portion of the location of the data write. At block 525, method 500 may include reading the at least portion of the data from the location of the data write. At block 530, method 500 may include validating the data written to the location of the data write.

The operation(s) at block 505-530 may be performed using the head verification module 130 described with reference to FIGS. 1-4 and/or another module. Thus, the method 500 may provide for efficient storage drive read-write head verification. It should be noted that the method 500 is just one implementation and that the operations of the method 500 may be rearranged, omitted, and/or otherwise modified such that other implementations are possible and contemplated.

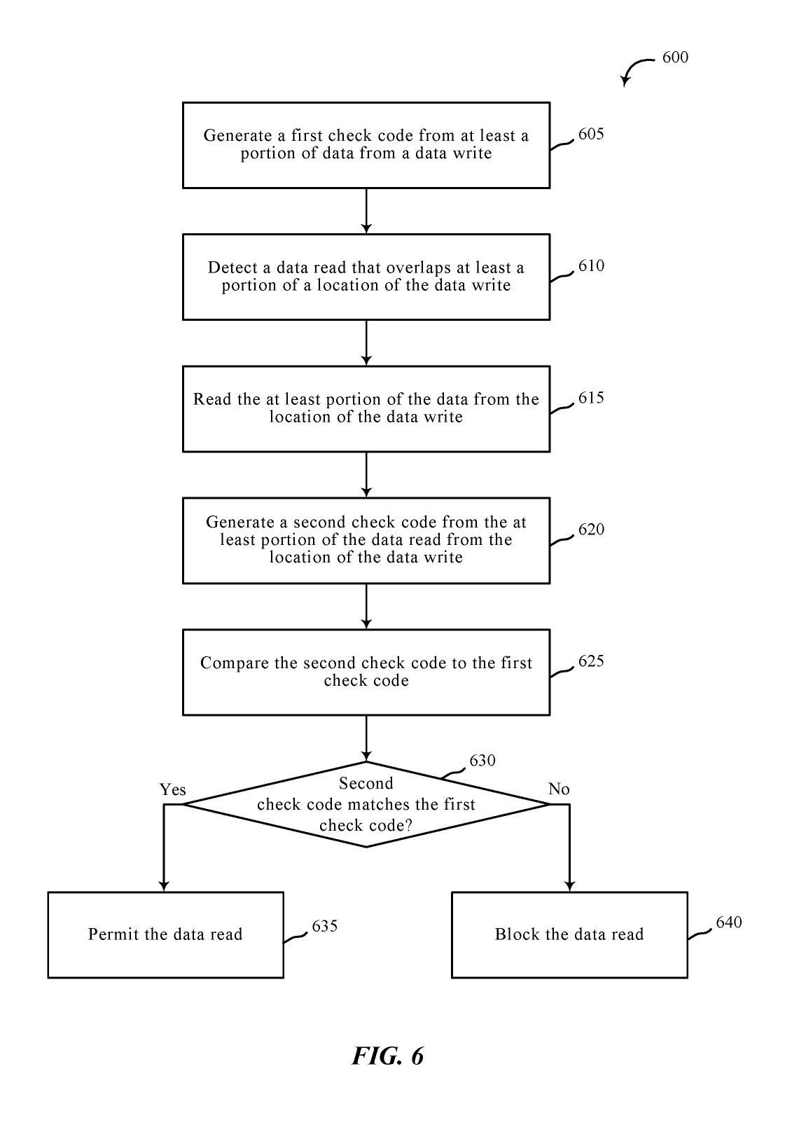

FIG. 6 is a flow chart illustrating an example of a method 600 for efficient storage drive read-write head verification, in accordance with various aspects of the present disclosure. One or more aspects of the method 600 may be implemented in conjunction with device 105 of FIG. 1, apparatus 205 of FIG. 2, and/or head verification module 130 depicted in FIGS. 1, 2, 3, and/or 4. In some examples, a backend server, computing device, and/or storage device may execute one or more sets of codes to control the functional elements of the backend server, computing device, and/or storage device to perform one or more of the functions described below. Additionally or alternatively, the backend server, computing device, and/or storage device may perform one or more of the functions described below using special-purpose hardware.

At block 605, method 600 may include generating a first check code from at least a portion of data from a data write. At block 610, method 600 may include detecting a data read that overlaps at least a portion of a location of the data write. At block 615, method 600 may include reading the at least portion of the data from the location of the data write.

At block 620, method 600 may include generating a second check code from the at least portion of the data read from the location of the data write. At block 625, method 600 may include comparing the second check code to the first check code. At block 630, method 600 may include determining whether the second check code matches the first check code.

At block 635, upon determining the second check code matches the first check code, method 600 may include permitting the data read. At block 640, upon determining the second check code fails to match the first check code, method 600 may include blocking the data read. In some cases, upon determining the second check code fails to match the first check code, method 600 may include generating a notification indicating a data integrity error. In some examples, method 600 may include reporting the notification to a host of the storage drive or an administrator of the storage drive, or to both.

The operations at blocks 605-640 may be performed using the head verification module 130 described with reference to FIGS. 1-4 and/or another module. Thus, the method 600 may provide for efficient storage drive read-write head verification. It should be noted that the method 600 is just one implementation and that the operations of the method 600 may be rearranged, omitted, and/or otherwise modified such that other implementations are possible and contemplated.

In some examples, aspects from two or more of the methods 500 and 600 may be combined and/or separated. It should be noted that the methods 500 and 600 are just example implementations, and that the operations of the methods 500 and 600 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, for example, a combination of a DSP and a microprocessor, multiple microprocessors, one or more microprocessors in conjunction with a DSP core, and/or any combination thereof.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC, or A and B and C.

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, or any combination thereof, then the coaxial cable, fiber optic cable, twisted pair, DSL, or wireless technologies such as infrared, radio, and/or microwave are included in the definition of medium. Disk and disc, as used herein, include any combination of compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to storage system applications. In some embodiments, the concepts, the technical descriptions, the features, the methods, the ideas, and/or the descriptions may specifically apply to storage and/or data security system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A storage system comprising:
a storage drive; and
a hardware controller configured to:
perform a data write, the data write comprising writing data to a storage medium of the storage drive;
identify a location of the data write;
generate a first check code from at least a portion of the data from the data write;
detect a data read that overlaps at least a portion of the location of the data write;
read the at least portion of the data from the location of the data write; and
validate the data written to the location of the data write.

2. The storage system of claim 1, wherein the hardware controller is further configured to:
generate a second check code from the at least portion of the data read from the location of the data write.

3. The storage system of claim 2, wherein the hardware controller is further configured to:
compare the second check code to the first check code.

4. The storage system of claim 3, wherein the hardware controller is further configured to:
upon determining the second check code matches the first check code, permit the data read.

5. The storage system of claim 3, wherein the hardware controller is further configured to:
upon determining the second check code fails to match the first check code, block the data read.

6. The storage system of claim 3, wherein the hardware controller is further configured to:
upon determining the second check code fails to match the first check code, generate a notification indicating a data integrity error; and
report the notification to a host of the storage drive or an administrator of the storage drive, or to both.

7. The storage system of claim 1, wherein identifying the location of the data write includes identifying a starting logical block address (LBA) of the data write.

8. The storage system of claim 7, wherein identifying the location of the data write includes identifying a data length of the data write.

9. The storage system of claim 8, wherein the data length is measured by blocks, wherein the storage drive includes a hard disk drive.

10. The storage system of claim 8, wherein the hardware controller is further configured to:
index the data write, wherein indexing the data write includes indexing at least one of a head used to perform the data write, indexing the starting LBA of the data write, or indexing the first check code, or any combination thereof; and wherein indexing the data write includes storing the indexing of the data write on the storage medium.

11. A method to improve a storage system comprising:
performing a data write, the data write comprising writing data to a storage medium of a storage drive;
identifying a location of the data write;
generating a first check code from at least a portion of the data from the data write;
detecting a data read that overlaps at least a portion of the location of the data write;
reading the at least portion of the data written to the location of the data write; and
validating the data written to the location of the data write.

12. The method of claim 11, comprising:
generating a second check code from the at least portion of data read from the location of the data write.

13. The method of claim 12, comprising:
comparing the second check code to the first check code.

14. The method of claim 13, comprising:
upon determining the second check code matches the first check code, permitting the data read.

15. The method of claim 13, comprising:
upon determining the second check code fails to match the first check code, blocking the data read.

16. The method of claim 13, comprising:
upon determining the second check code fails to match the first check code, generating a notification indicating a data integrity error; and
reporting the notification to a host of the storage drive or an administrator of the storage drive, or to both.

17. The method of claim 11, wherein identifying the location of the data write includes identifying a starting logical block address (LBA) of the data write.

18. The method of claim 17, wherein identifying the location of the data write includes identifying a data length of the data write.

19. A computer-program product to improve a computer system, the computer-program product comprising a non-transitory computer-readable medium storing instructions thereon, the instructions being executable by one or more processors to perform the steps of:
performing a data write, the data write comprising writing data to a storage medium of a storage drive, wherein the storage drive includes a hard disk drive;
identifying a location of the data write;
generating a first check code from at least a portion of the data from the data write;
detecting a data read that overlaps at least a portion of the location of the data write;
reading the at least portion of the data written to the location of the data write; and
validating the data written to the location of the data write.

20. The computer-program product of claim 19, wherein the instructions executed by the one or more processors cause the one or more processors to perform the steps of:
generating a second check code from the at least portion of data read from the location of the data write;
comparing the second check code to the first check code;
upon determining the second check code matches the first check code, permitting the data read; and
upon determining the second check code fails to match the first check code, blocking the data read.
